(19) United States
(12) Patent Application Publication
(10) Pub. No.: US 2005/0198673 A1
(43) Pub. Date: Sep. 8, 2005

(54) Satellite TV security system

(76) Inventors: John Kit, New York, NY (US); John F. Luk, New York, NY (US); Wai-Tat Luk, Marlboro, NJ (US)

Correspondence Address: John F. Luk, 30-30 150th Street, Flushing, NY, 11354-2452, US

(21) Appl. No.: 10/981,377

(22) Filed: Nov. 3, 2004

Related U.S. Application Data
(60) Provisional application No. 60/516,790, filed on Nov. 3, 2003.

(51) Int. Cl. H04N 7/18; H04N 7/20; H04N 7/16; H04N 9/47

(52) U.S. Cl. 725/68; 725/63; 348/143

(57) ABSTRACT

A satellite TV security system including a TV satellite operated by a satellite TV provider directed to a television set of a satellite TV subscriber that defends the satellite TV provider from illegal reception of TV signals from a TV satellite. An addressable integrated receiver/decoder (IRD) positioned in the TV set top box has an assigned identification number and a smart card positioned in the IRD has an assigned identification number. A security module is provided that is integrated with the IRD. Upon command of the satellite TV provider or automatically, the security module makes a periodic verification of a match of the two identification numbers. Lack of verification of a match triggers a signal from the security module to the IRD to stop transmitting TV signals to the subscriber television. As an alternative verification, the security module initiates periodic verifications of the operability of the telephone line connection between the satellite TV provider and the IRD of the subscriber. Lack of verification of the operability of the telephone line triggers a signal from the security module to the IRD to stop transmitting TV signals to the subscriber TV. The two systems of verification can be operated independently or simultaneously. The subscriber telephone number can be added as an assigned identification number, so that a three-way verification of identification numbers by the security module is required for continued transmission of TV signals to the subscriber television.

### REFERENCE TO RELATED U.S. APPLICATION DATA

This application claims benefit of U.S. Provisional Application No. 60/516,790 entitled, “Satellite TV Security System” filed on Nov. 3, 2003.

### FIELD OF THE INVENTION

This invention relates to satellite TV communication systems and particularly to the transfer and receipt of data signals between satellite TV service providers and subscriber TV set top box receivers.

### BACKGROUND AND DESCRIPTION OF THE PRIOR ART

Satellite communications have been around since the early 1940's. More recently, satellite TV or digital satellite system (DSS) or digital broadcast satellite (DBS) systems started becoming available around the mid-1990s. Satellite TV systems provide TV viewing of audio and video signals and other programming to customers via the airway. Satellite TV systems include landline cable TV systems and land based telephone line systems, only the latter being the field of the present invention.

Satellite TV systems use satellite audio and video signal distribution systems that generally include an earth station that compiles a number of individual audio and video programs into a broadband signal, modulates carrier frequency band with the broadband signal, and then transmits or uplinks the modulated signal to one or more geosynchronous satellites. The satellites amplify the received signals, shift the signals to different carrier frequency bands, and then transmit or downlink the frequency-shifted signals back down to earth.

A problem with the type of satellite TV system that uses a landline based telephone connection is that although the telephone landline is necessary to communicate with the satellite TV service provider to update billing cycles, such a connection is not continually monitored and verified by the provider and is presently not required to be in place in order to view satellite TV programming. Each satellite TV set top box receiver is assigned a serial number identification code and accepts a modular smart card assigned its own unique identification number. A satellite TV hacker, or pirate, can steal satellite TV signals that contain the TV set top box receiver serial identification number and the smart card identification number, and can then use this data to create a duplicate false or cloned smart card that can be used to steal satellite TV programs. The TV pirate does not connect with the satellite TV provider by the telephone landline, and simply watches stolen satellite TV programs without detection by the satellite TV provider. The satellite TV provider is unable to detect this piracy for the reasons that the telephone landline connection is not verifiable even for legitimate satellite TV users, and also because no system exists that verifies a match between each TV set top box receiver serial number identification code and the modular smart card with its own unique identification number.

During the transmission of digital broadcast, video, audio and related information data signals are digitally encoded into a packeted data bit stream using a number of algorithms. Conventional digital broadcast systems include a TV provider receiver station that receives and processes the transmitted packets of data. One type of receiver station is part of a “wireless digital television” system known commercially by the trade name DSS. The DSS system, which is utilized by the DIRECTV broadcast service, allows consumers to receive directly in their homes over 225 television channels broadcast from several powerful satellites. Other satellite TV service providers include Dish Network and Echostar. Present satellite TV systems are unidirectional and require inline aiming and alignment of the transmitting satellite with a small 18-inch receiving dish antenna. A satellite TV service provider downloads a scrambled signal to individual subscribers through the receiver dish and a LNB (Low Noise Block) located at each subscriber's residence. The signal from the LNB is then sent to a TV set top box receiver by way of a coaxial cable that decodes and descrambles the signal and allows the subscriber to view the authorized channels and programmed events. The TV set top box receiver is an electronic device designed to connect the TV with a satellite connection to provide video and audio to the TV (on top of which it normally sits) and is connected to other communication channels, such as telephone lines for billing information.

The TV set top box receiver is also known in the art as an addressable integrated receiver/decoder (IRD), which will be the term most often used herein. Each IRD contains a serial number identification code, indicated herein as the IRD identification number, and accepts a modular smart card with its own unique smart card identification number. A smart card is a credit card sized card that contains a microprocessor, memory, and input/output (I/O) means for data storage and program storage. The IRD and smart card identification numbers are matched and married to each other at the time of setting up the new account. The matched ID numbers are obtained and documented during normal subscription setup and may be linked to a land based telephone number preferably with the same land base telephone line and phone number the TV set top box receiver is connected to during setup. In addition, although the land based telephone line is not needed for satellite TV reception, the landline has to be attached to the IRD in the initial setup process. The satellite TV service provider needs to gain access to the IRD to setup the subscriber's account and also to retrieve billing information. The smart card stores the subscriber's basic monthly programming channels, special tier programming, and any new Pay-Per-View (PPV) purchase information. The basic reason for the land based telephone line connection is to send the PPV billing information back to the satellite TV service provider for updated account information. The descrambler in the IRD does not “talk back” to the main satellite. The TV set top box receiver typically uses an automatic PPV ordering system called VIDEOPAL. PPV programs are ordered through the IRD and the information is stored in the smart card. With the IRD hooked to a telephone line, a remote control is used to place a call to the order center at least once a month and tell them what movies have been ordered. The subscriber's bill is adjusted accordingly. Logistically, the land based telephone line for business reasons is connected to allow the IRD to communicate with the satellite TV service provider. For operational performance, however, the land based telephone line is not necessary for satellite TV operation and signal reception. The telephone landline can be disconnected and the original authorized programming including PPV purchases can still function until the allowable credit amount stored in the smart card is exceeded. At which time, the subscriber will have to reconnect the land based telephone line back into the IRD again for a reset or clearing of the PPV billing information.

There are some drawbacks to the way existing satellite TV communication systems are operated. The ability for the system to function without a direct feedback link between the satellite TV service provider and subscriber creates a security breach and allows hackers, or pirates in the case of satellite TV theft, an opportunity to steal and pirate satellite TV signals. Most subscriptions to the “generic” cable channels, which do not include premium or movie channels will cost between $240 to $480 a year above the cost of the initial hardware i.e. dish, receiver, etc. Some believe this is why satellite piracy has flourished. It is estimated that the Canadian broadcasting system alone is losing an estimated $400 million a year to satellite TV services pirating and more than likely the same numbers hold true for American based satellite TV systems as well. Piracy is illegal. If caught, a pirate or hacker can be fined or jailed. But this is a risk many TV pirates are willing to take.

In the case of illegal interception of satellite TV broadcasts, TV pirates generally do not come in from the outside via the land based telephone line and steal the legitimate subscription code information to clone a card for the simple reason they would most likely be caught. A cloned smart access card is a copy of a smart card containing a valid subscription code. Cloning is the main method of pirating satellite TV signals. Satellite TV pirates create a clone card either from a personal legitimate subscription, or from a legitimate subscription of a third party, or even from a random choice of legitimate subscription numbers generated by a smart card reader program. A telephone line connection, either by physical landline based phone line hookups or connection through the use of power line carrier communication (PLC) type devices, or more rarely connection through the airwaves, is not required to receive and decode the satellite TV signals. In present satellite TV systems, there is no direct communication between the standard TV set top box receivers or IRDs and the satellite TV service providers for the reason that satellite TV signals are unidirectional. Therefore the TV pirates have the advantage and will take the opportunity to steal TV programs directly from satellite TV broadcast signals. TV pirates use the cloned access cards for themselves or sell them to other illegitimate users o pirate satellite TV signals.

In addition, disconnection of a direct telephone line link disallows the satellite TV service provider active real-time access to the identification information provided on the receiver box and smart card. Lastly, frequent allowed disconnection of the telephone line connection between the IRD and the satellite TV service provider defeats the software present in the IRD by making it impossible the transmission of verification and authorization information and data on a repeated or random basis either actively or passively. It is apparent that the present satellite TV architecture therefore has an embedded flaw, because it does not require a telephone landline or other equivalent means of communications link to be connected at all times. Thus, when a user disconnects for any reason the telephone line to which the IRD is attached, the satellite TV service provider cannot properly track legitimate key subscription code data relating to the smart card and TV set top box receivers.

In view of the present state of the art it is reasonable to project that the satellite TV service provider sends out a stream of data headers along with the broadcast programming embedded in the satellite TV signal. This main signal data stream contains legitimate smart card and IRD identification number pairs. In some cases, only legitimate smart card identification numbers would be required that would effectively cause the mismatched smart card and TV set top box receiver to stop working. In view of the present state of the art it is reasonable to project that this system works more efficiently for random subscriber generated numbers than for clones of legitimate subscriptions. Occasionally, legitimate subscribers may also lose their IRDs and/or smart cards authorizations when the satellite service provider sends out a global shutdown data stream signal or Electronic Counter Measures (ECM) on a regular basis.

Expensive hardware including a new transceiver IRD modem and new LNB or new satellite TV dish could be installed to provide bi-directional communications directly back to the main satellite as in the case of DIRECWAY broadband satellite system for high-speed Internet access. The cost for the modem at the time of the preparation of this application was offered at a price of $579.98 with a service fee of $59.99 per month. This price does not include delivery and installation, and it does not include regular satellite TV broadcast signals from DIRECTV for example. As anyone can easily see, the cost of digital broadband satellite systems is beyond the reach of most households. In addition, because satellite communication systems rely on line of sight, and the fact that they are located over 22,000 miles from earth, they will produce some delay or “latency” during transmissions. They do not offer the speeds and reliability required for mission critical networks and virtual private networks (VPN) required for “twitch” games or online trading when compared to conventional hard-wired land based broadband data lines.

It is desirable to have a method and system to prevent the illegal pirating of satellite TV signals, thereby lowering monthly service charges paid by legal satellite TV subscribers. Although bi-directional broadband digital services presently exist to some degree, they are expensive, slow, and unreliable. The present invention provides the most reliable and cost-effective means for maintaining a two-way constant and continuous link between the satellite TV service provider and an improved IRD using related hardware and software for a more secure satellite TV system.

A variety of patents and publications on satellite communications, satellite TV and digital cable, and power line carrier systems exist. But none disclose a satellite security system that periodically searches to verify a match between the smart card identification number and the IRD identification number combined with a signal to terminate satellite TV service when a non-match is detected. Generally, these patents and publications do not disclose a means of verifying a constant and continuous telephone line connection feedback data link between the satellite TV service provider and individual subscriber IRDs. They do not disclose a means to constantly verify a permanent telephone line connection established between the TV set top box receiver and the satellite TV service provider, while either simultaneously or independently conduct verification and authentication checks relating to the IRD and the smart card with the results interlinked with the telephone line connection for transmission to the satellite TV provider with possible automatic termination of satellite TV service.

Lastly, although a variety of power line carrier telephone voice and/or data communication systems have been developed and are used to facilitate telephonic voice and data communications in locations where little or no availability exists for dedicated telephone wires, and others have devices that are connected to existing power lines, none disclose a means of maintaining a constant and continuous bi-directional data link for use with a standard land based telephone line hookup or with a data communication telephone jack modem setup.

The reader is referred to the following U.S. patent documents for general background material.

U.S. Pat. No. 5,237,610 issued to Gammie et al on Aug. 17, 1993, discloses a security system with particular application to Pay Per View TV satellite programs that use signal scrambling techniques to prevent a pirate from reading or modifying the decryption process. FIG. 5 therein shows a prior art TV satellite link system that has a replaceable security module 514 that is mounted to the TV set as set forth on page 6, lines 18-68 and page 7, lines 1-2 therein. Although the replaceable security module has the advantage of providing a guarantee that network security is recoverable following a breach, it also has some disadvantages. All the security resides in replaceable security module 514 and decoder 506 itself is a generic unit. The key signal, which is generated by replaceable security module 514, is observable at its transfer point to decoder 506. The key can, however, be changed sufficiently often to ensure that it has no value to a potential pirate. The problem with this approach is that a given removable security module 514 will operate with any decoder 506, and that tampering with replaceable security module 514 does not involve damage to decoder 506. Consequently, if replaceable security module 514 were to be comprised, piracy would become widespread very rapidly.

U.S. Pat. No. 5,237,610 further describes multiple key encryption systems as exemplified in prior art FIG. 11. This system has deficiencies of cost and of the difficulty of addressing all subscribers. U.S. Pat. No. 5,237,610 provides a replaceable security module 714 as shown in FIG. 7 that double encrypts key 718 using two different secret serial numbers assigned to a subscriber's TV decoder and also to the removable security module 714. External security module 714 can be replaced without any disruption in a subscriber's reception of authorized signals. The invention is able to twice encrypt the key prior to transmission first with a first secret serial number (SSN sub. 0) and again with a second secret serial number (SSN sub.1).

The present invention bypasses the replaceable hardware and multiple encryption keys of Gammie. The present invention adds to the security systems as described by Patent '610 or the prior art security systems described in Patent '610.

U.S. Pat. No. 4,748,668 discloses a method, apparatus, and article for identification and signature for a smart card and verification system used presently by DIRECTV systems and gives good information on their existing operating procedure.

U.S. Pat. Nos. 5,844,620 and 6,374,404 and U.S. Publication numbers 20020100059, 20020129358, and 20020104093 all refer to digital cable type systems and are referenced for background information.

U.S. Pat. Nos. 6,107,912, 6,243,571, 6,246,868, and 6,567,474 and U.S. Publication numbers 20020031226, 20020041228, and 20020080010 all refer to power line carrier communication (PLC) based systems and devices that the present invention may incorporate.

U.S. Pat. No. 6,134,419 relates to Digital Satellite Systems and methods of delivering broadcast satellite TV signals to multiple dwellings.

U.S. Publication 20020146125 discusses a common system for various broadcast service providers to share a common billing system.

U.S. Pat. Nos. 6,308,280 and 6,323,909, and U.S. Publications 20010052856 and 20020059637 all disclose further details on satellite TV broadcast systems and the like.

U.S. Pat. No. 6,205,473 teaches a satellite broadband system and method for asymmetric satellite communications for local area networks.

U.S. Pat. No. 6,441,782 teaches a method and system of directing an antenna in a two-way satellite system. Although this patent discloses a two-way satellite broadband system for Internet connection via a satellite TV service provider to the same subscriber's satellite, it does not teach the benefit of a two-way connection between the TV set top box and the satellite TV service provider. Further detail shows the broadband connection from a special satellite dish is directed to a cable modem and finally to a local PC. A separate one-way connection exists from the same special satellite dish directly to the TV set top box receiver.

The present invention provides a satellite TV security system that provides an improved IRD that includes a security module including hardware and/or software that can periodically verify that the smart card identification number and the IRD identification number match, and in the case of a non-match provides a termination of satellite TV service to the TV subscriber.

The present invention also provides an improvement to existing satellite TV systems by requiring a permanent telephone line connection between the TV set top box receiver (IRD) and the satellite TV service provider.

There are alternative embodiments of the present invention for maintaining a constant and continuous communications link between the satellite TV service provider and the improved IRD or TV set top box receivers of individual subscribers.

One such alternative embodiment utilizes the known system of power line carrier communication (PLC) technology previously described with a land based telephone line imposed on the carrier frequency of standard power lines to transmit and receive information between the improved IRD receiver, which has the characteristic of a transceiver in the TV set top box and the satellite TV service provider. The use of power line communication (PLC) technology or analogous methods of imposing data over AC power lines are well known in the art. PLC data is transmitted on an existing AC power line simultaneously with the electrical AC line current already present for delivering electrical power. Using the AC power line as the medium for data communications is particularly convenient because a power line will always be present to provide AC power to the improved TV set top box IRD. A number of protocols including X-10, CEBus, Lonworks, and PowerPacket have been developed for PLC technology. The readily commercial availability of chip sets designed for PLC devices makes the AC power line a feasible medium for telephonic voice and data communications. PLC devices are used when rewiring the home, building, or other structures limit many homeowners from setting up or networking electronic devices, such as telephones and computers, in the home. PLC devices allow the homeowner to install electronic devices anywhere there is an electrical outlet without running new wires. It becomes especially convenient to use PLC telephone modem jacks to bring telephone line voice and data communications to any device via the power line that does not have a physical land based telephone line jack nearby.

There is known in the art commercially available external devices, among many others, that transpose telephonic voice and data signals over the AC power line, thereby eliminating the need to physically attach a telephone line to a TV set top box IRD. These devices are readily available from companies such as Phonex Corporation located in Midvale, Utah. Phonex markets a Wireless Jack for Modems PN: PX-441 consisting of a base and extension set retailing at $99.99 a set. Additional extensions PN: PX-442 can be bought at $49.99 each. The external wireless jack device consists of two components, one serves as a PLC transmitter or base unit, and the second device serves as a PLC receiver or extension unit. A telephone line is attached to the PLC base or transmitter unit located somewhere remote from the TV set top receiver box. The PLC extension unit is located closer to the TV set top box IRD and a telephone line cable is connected from the output jack of the PLC extension unit to the input jack of the TV set top box IRD. This PLC phone line arrangement can be used in special cases where a telephone line to the existing TV set top box IRD may be cumbersome or not conveniently available. It should be noted that an internal PLC receiver extension unit can be incorporated in the electronic circuitry contained within the TV set top box IRD, thereby eliminating the need to have an external PLC receiver unit.

Since there are many analogous commercial power line data receiver modules available from multiple vendors, the structures, circuitry and principles of which are well known in the art, they need not be described in detail here.

Another embodiment of the present invention involves a landline telephone system that utilizes the transmission of data over power lines by the use of an array of cellular towers to transmit the data from the improved TV set top box IRD back to the satellite TV service provider via wireless cellular telephone line carriers. The use of wireless cell telephones and cellular towers can be used to tie directly into the improved TV set top box IRDs to act as the link between the improved TV set top box IRDs and the satellite TV service provider. If the cellular signal from the TV set top box IRD is not strong enough to reach the main satellite TV provider, cellular towers can be combined with separate repeaters or access points that can boost and relay the individual cellular signal from each subscriber's IRD to other cellular towers and so on until the return identification data information reaches the main satellite TV provider.

The three known data transmission systems for establishing a telephone landline connection described herein allow for a constant and continuous connection between the individual subscriber nodes and the satellite TV provider. Once a permanent and constant telephone landline communications link has been established, the satellite TV service provider can send out digital data communication strings with legitimate subscription headers either in series or parallel format, or a combination of both formats for both legal smart card and IRD identification numbers. Only if the unique identification numbers of the improved TV set top box IRD and the smart card are verified and authenticated will the programming signal sent by the satellite TV provider by way of the main TV satellite be decoded by the IRD and thereupon the video and audio signals are transmitted to the TV for viewing.

In all three data transmission systems described, the IRD and smart card identification numbers should be checked continuously, randomly, or alternatively as requested by the central satellite TV service provider. Such verification can be provided either by a satellite TV security modem software integrated within the electronics IRD or by special software at the satellite TV provider. Alternatively, the telephone landline connection can be likewise checked continuously, randomly or as requested by the central TV service provider either as a stand alone security system or in combination with the system of verification of the match of the smart card identification number and the IRD identification number. Finally, both systems of verification of smart card and IRD identification numbers and verification of the telephone landline can be combined to provide double security.

If verification is not made or if a smart card duplication is found, then a signal flag will be set and that data string will either be resetted, disabled, or turned off and the improved IRD and smart card can be disabled. Any such condition indicates that possible pirating has been committed. The legitimate subscriber will have to contact the main satellite TV service provider to get a new account. Repeated incidences of duplication with the same subscriber may warrant further investigation. Smart cards can be cloned and IRDs serial numbers can be emulated, but when the codes or subscriptions of the smart card and TV set top box transceiver identification numbers are not verified as legitimate or show duplications, then the signal to that particular IRD and smart card pair will be terminated, or the IRD will be ordered by the satellite TV provider to terminate the decoding of the satellite TV signal.

Existing satellite TV service providers can manufacture and supply smart addressable transceiver boxes and replace existing standard “dumb” receivers or IRDs with improved IRDs having satellite TV security modems. The cost of replacement and new systems should be significantly less than the millions of dollars lost by the pirating and illegal theft of satellite TV signals each year.

A satellite TV security system in accordance with the present invention that is a substantial improvement over the prior art mentioned above will be appreciated by those skilled in the art from the following summary and detailed description of the invention.

### SUMMARY OF THE INVENTION

It is an object of the present invention to provide a system to thwart the illegal pirating of satellite TV signals.

It is another object of the present invention to provide a method and a system to examine, compare, and authenticate both a satellite TV smart card identification number and a satellite TV IRD identification number.

It is yet another object of the present invention to provide a means for disabling the transmission of decoded TV signals from said IRD to the subscriber upon detection of the lack of verification of a match between the smart card identification number and the satellite TV IRD identification number.

It is yet another object of the present invention to provide a method and a system to examine, compare, and authenticate a satellite TV smart card identification number, satellite TV IRD identification number, and a subscriber telephone number.

It is yet another object of the present invention to provide a means for disabling the transmission of decoded TV signals from said IRD to the subscriber upon detection of the lack of verification of a match between the smart card identification number, the satellite TV IRD identification number, and the subscriber telephone number.

Another object of this invention is to verify a standard land based telephone line connection to establish the constant and continuous communications link between a satellite TV user and a satellite TV provider along with an improved IRD including a satellite TV security module to enable the examination, comparison, and authentication of satellite TV smart card and satellite TV IRD identification numbers, and subscriber telephone numbers.

Yet another object of this invention is to use a continuous telephone communications link utilizing power line communication (PLC) modem devices along with improved IRDs to verify a continuous and verifiable communications link.

The present invention will be better understood and the objects and important features, other than those specifically set forth above, will become apparent when consideration is given to the following details and description, which when taken in conjunction with the annexed drawings, describes, illustrates, and shows preferred embodiments or modifications of the present invention and what is presently considered and believed to be the best mode of practice in the principles thereof.

Those skilled in the art will further appreciate the improvements and advantages relating to satellite TV security systems upon reading the detailed description that follows in conjunction with the following drawings.

### BRIEF DESCRIPTION OF THE DRAWINGS

FIG. 1 shows a security system for a satellite TV system including a satellite TV dish antenna, a satellite TV security modem integrally mounted within an integrated receiver/decoder unit (IRD) installed in a TV set top box, and a smart card operationally inserted into the IRD with an optional standard telephone landline connecting the satellite TV provider and the satellite TV subscriber that is used for billing and special program ordering purposes only;

FIG. 2 shows a security system for a satellite TV system analogous to that shown in FIG. 1 with a continuous telephone landline that is operationally verifiable connecting the satellite TV provider and the satellite TV subscriber;

FIG. 3A shows another embodiment of the satellite TV security system shown in FIGS. 1 and 2 that includes a telephone landline connection comprising an internal power line carrier communication (PLC) unit and a Public Switched Telephone Network (PSTN) with an alternative standard telephone landline and a telephone landline selector switch in the mode of activating the PLC unit;

FIG. 3B shows the embodiment of the satellite TV security system shown in FIG. 3A with the telephone landline selector switch in the mode of activating the standard telephone landline;

FIG. 4 shows another embodiment of the satellite TV security system with an alternative telephone connection comprising a cellular based telephone carrier line using cellular towers connecting the satellite TV provider and the satellite TV subscriber wirelessly by airway;

FIG. 5 is a flow chart outline showing a procedure for a verification of a match between a smart card identification number and a subscriber IRD identification number, and also a verification of a telephone line connection between the satellite TV provider and the satellite TV subscriber with an automatic TV signal block, and

FIG. 6 is a flow chart outline showing a procedure for a verification of a match between a smart card identification number, a subscriber IRD identification number, and a subscriber telephone number, and also a verification of a telephone line connection between the satellite TV provider and the satellite TV subscriber with an automatic TV signal block.

### DETAILED DESCRIPTION OF THE INVENTION

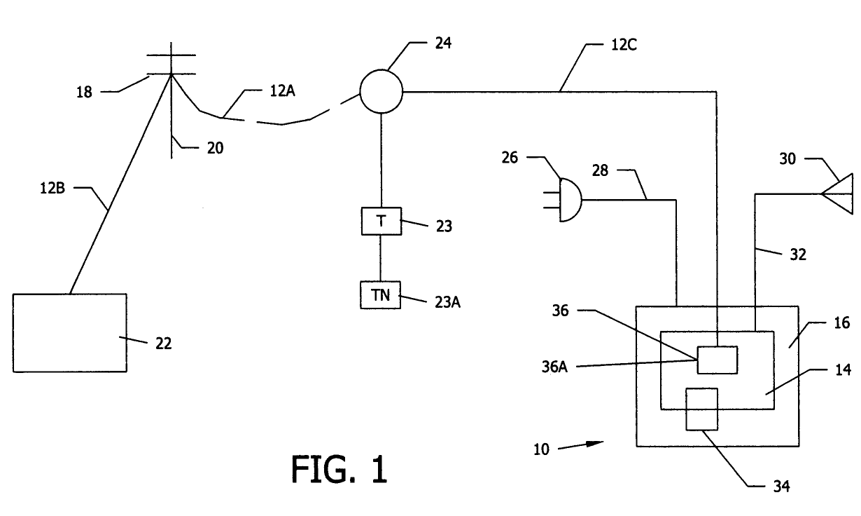

Reference is now made to the drawings and in particular to FIGS. 1-6 in which identical or similar parts are designated by the same or similar reference numerals throughout.

A schematic view of a basic satellite TV security system 10 in FIG. 1 shows an optional standard land based telephone line wire 12A that connects a satellite TV set top box receiver, that is, an addressable integrated receiver/decoder (IRD) unit 14 positioned within a TV set top box 16 connected to a telephone pole connector 18 on a telephone pole 20. TV set top box 16 is usually positioned on top of the TV set (not shown) of the satellite TV subscriber. Another standard landline based telephone wire 12B connects a satellite TV service provider 22 to telephone pole connector 18. Optional telephone wire 12A is connected to a house telephone jack 24 from where a house telephone wire 12C extends in operative connection to IRD 14. Telephone wires 12A, 12B, and 12C together comprise a standard telephone landline connection between satellite TV service provider 22 and IRD 14. A subscriber telephone (T) 23 is operationally connected to house telephone jack 24. Telephone (T) 23 has been assigned a subscriber telephone number (TN) 23A that is accessibly contained in the provider's data bank.

A power plug 26 is connected to a house socket (not shown) connected to the house AC power for providing AC power by power cord 28 to IRD 14. A satellite TV signal reception system includes a satellite TV dish antenna 30 and an antenna wire 32 connected to IRD 14. Satellite TV service provider 22 downlinks a scrambled or encoded one-way satellite TV signal to individual subscribers from a TV satellite (not shown) to satellite TV dish antenna 30. A low noise block (LNB) (not shown) is located at each subscriber's residence usually in conjunction with the satellite TV dish antenna. The satellite TV signal is transmitted to IRD 14 where it is descrambled, or decoded using existing decryption key systems. The decoded satellite TV signal is then transmitted to the subscriber TV set for viewing.

A smart access card 34 is mounted in operative relationship with IRD 14. Smart card 34 has been assigned a smart card identification number that distinguishes it from all other smart cards. IRD 14 has also been assigned an IRD identification number that distinguishes it from all other IRDs. Satellite TV security system 10 may draw power from the main AC power supply through AC plug 26 and AC power cord 28 for IRD 14 as shown or may alternatively be self-powered.

The standard telephone landline represented by telephone wires 12A, 12B, and 12C is shown in dash line in FIG. 1 to indicate that a constantly functioning telephone connection is not required for satellite TV system 10 in that only a telephone line connection is required for billing purposes from the satellite TV service provider 22 to the satellite TV subscriber. In addition, a telephone line is not required for the satellite TV satellite subscriber to order special events such as certain sports programming and Pay Per View. Instead, this can be done by means of a remote control operated by the subscriber.

With the land based telephone wire 12A optionally connected, satellite TV provider 22 cannot make an automatic command and periodic check or verification of a match between the smart card identification number and the IRD identification number. In this situation, the legitimate identification numbers can be downloaded from the TV satellite to TV dish antenna 30 and IRD 14 and further sending both IRD and smartcard identification numbers to a satellite TV security module 36, which contains software that performs the security task of verifying the two identification numbers and examining them for the required match. Security module 36 includes the software not only for making a match but also more basically has the means to detect any lack of the required match. Security module 36 also has the software means for signaling IRD 14 to disable the transmission of decoded TV signals from IRD 14 to the subscriber TV upon detection of the lack of verification of the required match.

If the smart card and IRD identification numbers do not verify, then an error message, such as by way of example, “YOUR SUBSCRIPTION IS NOT VALID. PLEASE CALL CUSTOMER SERVICE” is displayed on the TV set screen and IRD 14 stops decoding the satellite TV signal. When this situation occurs, it may mean the legal subscriber's account has been temporarily suspended, but more than likely it will be an indication that smart access card 34 was cloned and was not used when IRD 14 was recorded during subscription activation. At this point, satellite TV signals to the TV set for viewing are terminated.

In an alternative mode, satellite TV provider 22 can make an automatic command and periodic check or verification of a match between the smart card identification number, the IRD identification number, and the subscriber telephone number (TN) 23A as a subscriber telephone identification number from the TV satellite to TV dish antenna 30 and IRD 14 by signaling all three identification numbers to an alternative satellite TV security module 36A, which contains software that performs the security task of verifying the three identification numbers and examining them for the required match. Security module 36A includes the software not only for making a match, but also more basically has the means to detect any lack of the required matches. Security module 36A also has the software means for signaling IRD 14 to disable the transmission of decoded TV signals from IRD 14 to the subscriber TV upon detection of lack of verification of the required matches.

If the smart card, IRD identification, and telephone identification numbers do not verify, then an error message, such as by way of example, “YOUR SUBSCRIPTION IS NOT VALID. PLEASE CALL CUSTOMER SERVICE” is displayed on the TV set screen and IRD 14 stops decoding the satellite TV signal. When this situation occurs, it may mean the legal subscriber's account has been temporarily suspended, but more than likely it will be an indication that smart access card 34 was cloned and was not used when IRD 14 and subscriber telephone number (TN) 23A were recorded during subscription activation. At this point, satellite TV signals are terminated.

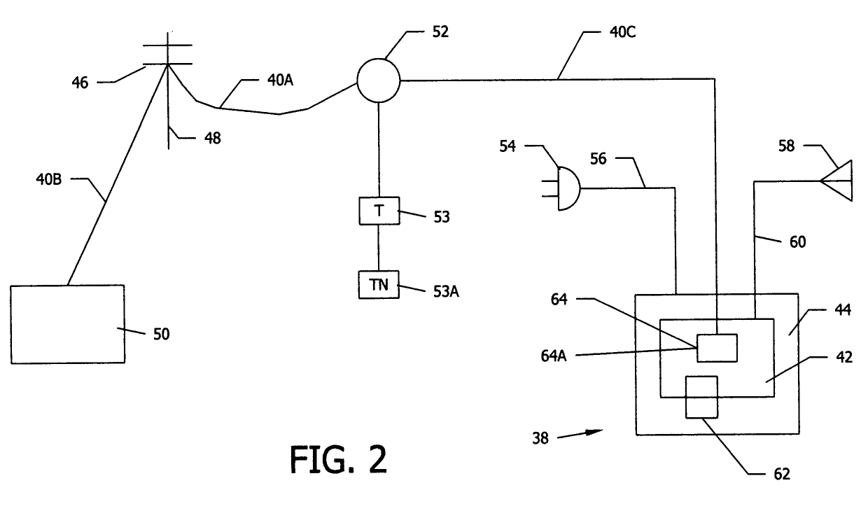

FIG. 2 shows a schematic view of another embodiment of the present invention. A satellite TV security system 38 is analogous in structure to satellite TV security system 10 shown in FIG. 1 except that security system 38 shows the present invention used in conjunction with a standard land based telephone line that is required to be operative at all times. Security system 38 includes a telephone wire 40A that connects a satellite TV set top box receiver, that is, an addressable integrated receiver/decoder (IRD) unit 42 positioned in a TV set top box 44. Telephone wire 40A is connected to a telephone pole connector 46 on a telephone pole 48. Another standard land based telephone line wire 40B connects a satellite TV service provider 50 to telephone pole connector 46. Telephone wire 40A is connected to a house telephone jack 52 from where a house telephone wire 40C extends in operative connection to IRD 42. Telephone wires 40A, 40B, and 40C together comprise a standard telephone landline connection between satellite TV service provider 50 and IRD 42. A subscriber telephone (T) 53 is operationally connected to house telephone jack 52. Telephone (T) 53 has been assigned a subscriber telephone number (TN) 53A that is accessibly contained in the provider's data bank.

In the embodiment of satellite TV security system 38, the standard telephone landline comprising telephone wires 40A, 40B and 40C is required to be in operative connection at all times and is subject to periodic verification by a satellite TV service provider 50 wherein if the telephone landline at any time fails, the test of operative verification signals are transmitted to IRD 42 to terminate decoded TV signals to the subscriber TV.

A power plug 54 is connected to a house socket (not shown) connected to the house AC power for providing AC power by power cord 56 to IRD 42. A satellite TV dish antenna 58 includes a satellite TV antenna wire 60. Digital broadcasts from satellite TV service provider 50 downlink a scrambled or encoded one way satellite TV signal to the satellite TV subscriber from a TV satellite (not shown) to satellite TV dish antenna 58 and satellite TV antenna wire 60 connected to IRD 42. An LNB is located at each subscriber's residence usually in conjunction with satellite TV dish antenna 58. The signal is transmitted to IRD 42 where it is descrambled or decoded using existing decryption key systems for eventual transmission to the subscriber TV set (not shown) for viewing.

A smart access card 62 is mounted in operative relationship with IRD 42. Smart card 62 has been assigned a smart card identification number that distinguishes it from all other smart cards. IRD 42 has also been assigned an IRD identification number that distinguishes it from all other IRDs. Satellite TV security system 38 may draw power from the main AC power supply through AC plug 54 and AC power cord 56 for IRD 42 as shown or may alternatively be self-powered.

The standard telephone landline shown represented by telephone wires 40A, 40B, and 40C is the continuous telephone connection shown in solid line required for the satellite TV security system shown in FIG. 2. Continuous encoded TV signals are transmitted from the TV satellite to satellite dish antenna 58 and then to IRD 42 where the encoded TV signals are decoded in accordance with existing decryption key systems. The decoded satellite TV signal is then transmitted to IRD 42 for eventual transmission to the subscriber TV set (not shown).

Satellite TV provider 50 can now perform automatic commands and periodic checks or verification of the operability of the telephone line connection comprising telephone wires 40A, 40B and 40C between satellite TV service provider 50 and IRD 42. Security module 64 is positioned in TV set top box 44, as is IRD 42. If there is no operational connection, security module 54 thereupon transmits a termination signal to IRD 42, which then stops decoding the satellite TV signal, and transmission of the decoded signal to the subscriber TV. In addition, an error message such as by way of example, “NO TELEPHONE LINE DETECTED. PLEASE CHECK CONNECTION” is displayed on the TV set screen of the TV subscriber.

In accordance with the function of security module 64, the software programmed therein loops and continues to check for a telephone line connection on a regular basis. The time interval between the periodic checks can vary.

When a phone line connection is verified by security module 64, the software of security module 64 can then additionally perform a backup verification of authenticity by reading the identification number of smart card 62 along with the identification number of IRD 42 and verifies a match there between or detects a lack of verification of a match. In the case of lack of verification of a match, security module 64 signals IRD 42 to terminate the transmission of the satellite TV signal to the TV set of the satellite TV subscriber.

If the smart card and IRD identification numbers do not verify, then an error message, such as by way of example, “YOUR SUBSCRIPTION IS NOT VALID. PLEASE CALL CUSTOMER SERVICE” is displayed on the TV set screen and IRD 42 stops decoding the satellite TV signal. When this situation occurs, it may mean the legal subscriber's account has been temporarily suspended, but more than likely, it will be a indication that smart access card 62 was cloned and was not used when IRD 42 was recorded during subscription activation. At this point, satellite TV signals are terminated.

In an alternative mode satellite TV provider 50 makes an automatic command periodic check or verification of a match between the smart card identification number, the IRD identification number, and the subscriber telephone number (TN) 53A as a subscriber telephone identification number from the TV satellite to TV dish antenna 58 and IRD 42 by signaling all three identification numbers to an alternative satellite TV security module 64A, which contains software that performs the security task of decoding the three identification numbers and examining them for the required match. Security module 64A includes the software not only for making a match but also more basically has the means to detect any lack of the required matches. Security module 64A also has the software means for signaling IRD 42 to disable the transmission of decoded TV signals from IRD 42 to the subscriber TV upon detection of lack of verification of the required matches.

If the smart card, IRD identification and telephone identification numbers do not verify, then an error message, such as by way of example, “YOUR SUBSCRIPTION IS NOT VALID. PLEASE CALL CUSTOMER SERVICE” is displayed on the TV set screen and IRD 42 stops decoding the satellite TV signal. When this situation occurs, it may mean the legal subscriber's account has been temporarily suspended, but more than likely it will be an indication that smart access card 62 was cloned and was not used when IRD 42 and subscriber telephone number (TN) 53A were recorded during subscription activation. At this point, satellite TV signals are terminated.

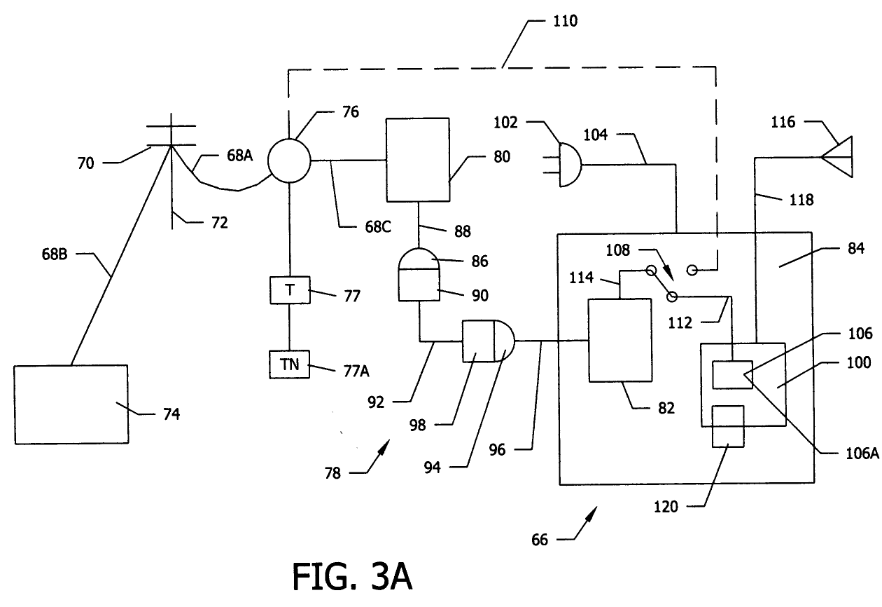

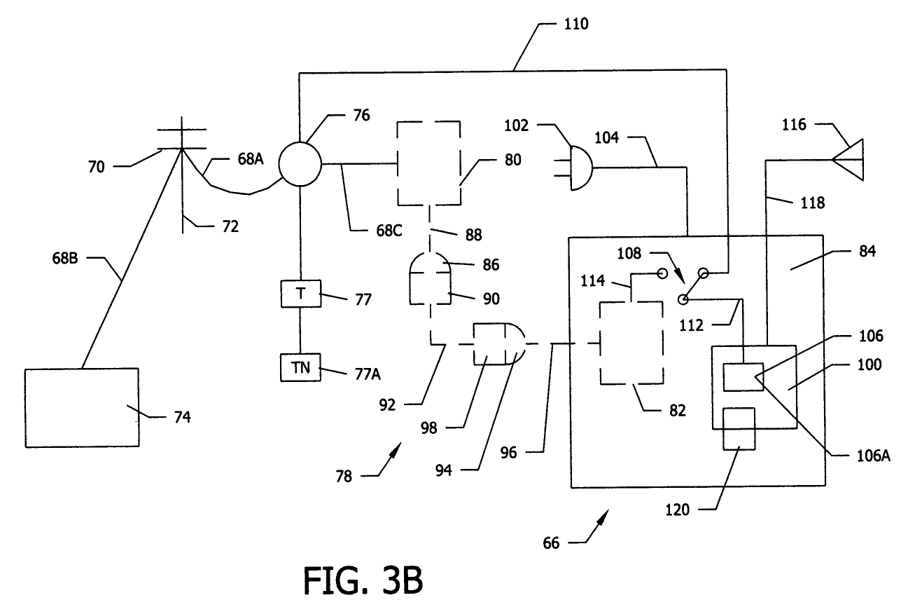

FIG. 3A shows satellite TV security system 66, which is an alternative embodiment of the present invention. Satellite TV security system 66 is used in conjunction with a land based telephone line that includes a telephone wire 68A that connects to a telephone pole connector 70 on a telephone pole 72 and another telephone wire 68B that connects a satellite TV service provider 74 to telephone pole connector 70. Telephone wire 68A is connected to a house telephone jack 76 from where house telephone wire 68C is in operative connection to a power line carrier communication (PLC) based system 78. A subscriber telephone (T) 77 is operationally connected to house telephone jack 76. Telephone (T) 77 has been assigned a subscriber telephone number (TN) 77A that is accessibly contained in the provider's data bank.

PLC system 78 includes a PLC transmitter base modem 80 and a PLC receiver extension modem 82, which may be positioned externally or internally mounted inside TV set top box 84. PLC base modem 80 includes a base PLC plug 86 with a plug power cord 88 connected to a nearby house wall socket 90 that is connected to a house AC power line 92. PLC extension modem 82 is mounted in TV set top box 84 and includes an extension PLC plug 94 with a plug power cord 96 connected to a convenient house wall socket 98 that is also connected to house AC power line 92.

An IRD 100 mounted in TV set top box 84 is connected by a plug 102 with a power cord 104 mounted to a house wall socket (not shown) that is connected to a house AC power line so as to power IRD 100. Satellite TV security system 66 may draw power from the main AC power supply for IRD 100 as shown or may alternatively be self-powered. AC power plug 102 may be integrally combined with PLC plug 94 and power cord 96 to minimize hardware. Internal wiring in TV set top box 84 distributes the power and data line signals accordingly.

A satellite security module 106 is located in TV set top box 84. Security module 106 is integrated with IRD 100. A switch 108 positioned in TV set top box 84 is accessible for operation from outside of TV set top box 84 to be operated to selectively connect security module 106 and IRD 100 either to PLC extension modem 82 and thus to PLC system 78 or on the other hand to a backup telephone wire 110 (shown in dash line) that is connected to house telephone jack 76. Switch 108 is shown in FIGS. 3A and 3B positioned to be selectively operated to connect to either telephone wire 110 or to telephone wire 114 in TV set top box 84. Telephone wire 114 is connected to PLC extension modem 82 and thus to PLC telephone line system 78. Telephone wire 112 is connected to security module 106 and to IRD 100.

Switch 108 can be optionally operated so as to connect telephone wire 112 to backup telephone wire 110 external to TV set top box 84 and to house telephone jack 76 or to telephone wire 114 internal to TV set top box 84 and then to house telephone jack 76. FIG. 3A shows switch 108 connected to telephone wire 114 so as to activate PLC system 78. Backup landline wire 110 is shown bypassed in FIG. 3A and as such is shown in dashed line indicating that backup line 110 is in an inactive mode. When switch 108 is operated to as to activate backup telephone wire 110 as shown in FIG. 3B, PLC system 78 is bypassed and inactivated as shown in FIG. 3B where PLC system 78 is shown in dash line and backup telephone wire 110 is shown in solid line.

A satellite TV dish antenna 116 connected to satellite TV wire 118 receives scrambled or encoded audio and video TV signals transmitted from a TV satellite (not shown) and sends them to IRD 100 for decoding in accordance with a decryption system. IRD 100 sends the decoded TV signals to the TV set (not shown) of the satellite TV subscriber for viewing.

A smart access card 120 is mounted in operative relationship with IRD 100. Smart card 120 has been assigned a smart card identification number that distinguishes it from all other smart cards. IRD 100 has also been assigned an IRD identification number that distinguishes it from all other IRDs.

Satellite TV service provider 74 can make an automatic command and periodic check or verification of a match between the smart card identification number and the IRD identification number transmitted from the TV satellite to TV dish antenna 116 or directly from a data bank securely located at satellite TV service provider 74 and then sends both identification numbers to IRD 100 in particular to security module 106, which performs the security task of decoding the two identification numbers and examining them for the required match. Security module 106 includes the software not only for making a match but also more basically has the means to detect any lack of the required match. Security module 106 also has the software means for signaling IRD 100 to disable the transmission of decoded TV signals from IRD 100 to the subscriber TV upon detection of the lack of verification of the required match to terminate decoded audio and video TV signals to the subscriber TV.

Satellite TV provider 74 can also alternatively make an automatic command periodic check or verification of the operability of the telephone line connection comprising PLC system 78 and telephone wires 68A, 68B and 68C between satellite TV service provider 74 and IRD 100.

IRD 100 is activated by a signal transmitted by the TV satellite and immediately or shortly thereafter, security module 106 is activated to verify that the telephone line connection between the satellite TV provider 74 such as the billing center is operational. If there is no operational connection, an error message such as by way of example, “NO TELEPHONE LINE DETECTED. PLEASE CHECK CONNECTION” is displayed on the TV set screen of the TV subscriber and thereupon IRD 100 stops decoding the satellite TV signal. The software programmed in security module 106 loops back and continues to check for a telephone line connection on a regular basis. The time interval between the periodic checks can vary.

The operational integrity of the telephone line connection can be initiated and accomplished in other ways. One such way is by security module 106 being self-activated by built-in electronic structures to verify the operational integrity of the telephone line at periodic intervals.

The assigned identification numbers of smart card 120 and IRD 100 can be translated to telephone data transmittable by telephone landline to the software means at satellite TV provider 74 that verifies a match between them using a legitimate subscriber's pair of identification numbers. If the identification numbers of both smart card 120 and IRD 100 match updated subscription information, then both identification numbers are authenticated by the software of the satellite TV provider 74. If such identification numbers do not match, a lack of verification termination signal is transmitted to the satellite TV to transmit a termination of TV service to IRD 100. This causes IRD 100 to terminate the descrambling and decoding of the satellite TV signals to the TV set for viewing. Alternatively any lack of verification of a match at the software of satellite TV provider 74 can result in the transmission of a telephone signal back to security module 106 and then to IRD 100 for a signal to cease descrambling and decoding of the audio and video satellite TV signals.

If the smart card and IRD identification numbers do not verify, then an error message, such as by way of example, “YOUR SUBSCRIPTION IS NOT VALID. PLEASE CALL CUSTOMER SERVICE” is displayed on the TV set screen and IRD 100 stops decoding the satellite TV signal. When this situation occurs, it may mean the legal subscriber's account has been temporarily suspended, but more than likely it will be an indication that smart access card 120 was cloned and was not used when IRD 100 was recorded during subscription activation. At this point, satellite TV signals are terminated.

In an alternative mode satellite TV provider 74 makes an automatic command and periodic check or verification of a match between the smart card identification number, the IRD identification number, and the subscriber telephone number (TN) 77A as a subscriber telephone identification number from the TV satellite to TV dish antenna 116 and IRD 100 by signaling all three identification numbers to an alternative satellite TV security module 106A, which contains software that performs the security task of verifying the three identification numbers and examining them for the required match. Security module 106A includes the software not only for making a match, but also more basically has the means to detect any lack of the required matches. Security module 106A also has the software means for signaling IRD 100 to disable the transmission of decoded TV signals from IRD 100 to the subscriber TV upon detection of the lack of verification of the required matches.

If the smart card, IRD identification, and telephone identification numbers do not verify, then an error message, such as by way of example, “YOUR SUBSCRIPTION IS NOT VALID. PLEASE CALL CUSTOMER SERVICE” is displayed on the TV set screen and IRD 100 stops decoding the satellite TV signal. When this situation occurs, it may mean the legal subscriber's account has been temporarily suspended, but more than likely it will be an indication that smart access card 120 was cloned and was not used when IRD 100 and subscriber telephone number (TN) A were recorded during subscription activation. At this point, satellite TV signals are terminated.

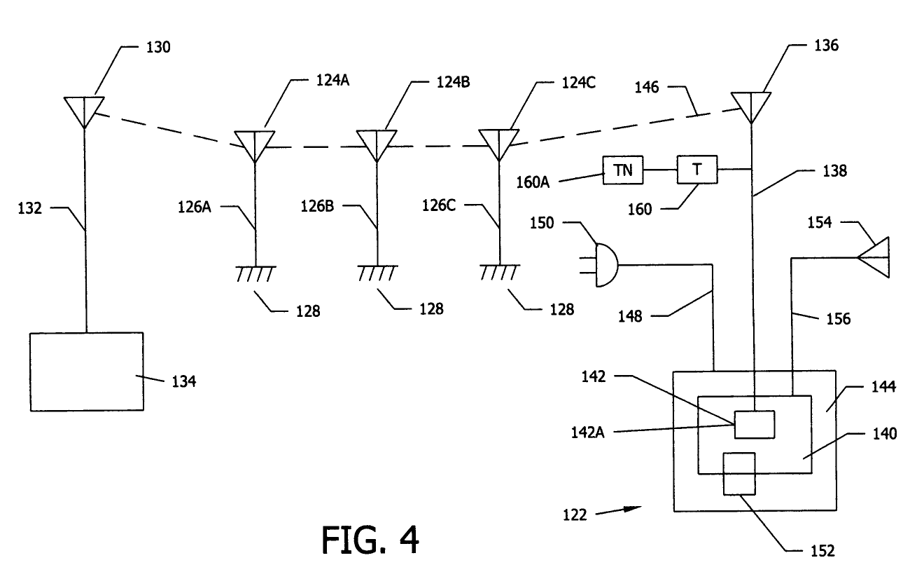

Another embodiment of the present invention is shown in FIG. 4 wherein is shown a satellite TV security system 122 that includes a telephone landline having airway transmission of telephone signals that includes for purposes of exposition spaced apart cellular telephone antennas 124A, 124B, and 124C mounted on towers 126A, 126B and 126C, respectively, each set upon ground 128. A cellular telephone antenna 130 with a telephone wire 132 connects to satellite TV service provider 134. Another cellular telephone antenna 136 with a telephone antenna wire 138 connects to an IRD 140 and to a security module 142 positioned in a TV set top box 144. Cellular telephone airway telephone signals 146 are transmitted between cellular telephone antennas 130, 124A, 124B, 124C and 136. IRD 140 and a satellite TV security module 142 are positioned in a TV set top box 144 of a satellite TV subscriber. If cellular airway telephone signals 146 are not strong enough to maintain communication between satellite TV provider 134 and IRD 140, cellular antennas 124A, 124B, and 124C are combined with separate repeaters or access points that boosts and relay each individual cellular signal between IRD 140 and other cellular antennas and satellite TV provider 134.

IRD 140 is connected to a house AC power line by an AC power cord 148 and a plug 150 mounted into a house wall socket (not shown). Satellite TV security system 122 may draw power from the main AC power supply for IRD 140 as shown or may alternatively be self-powered. A modular smart card 152 is mounted in operative connection to IRD 140.

A satellite TV dish antenna 154 with a satellite TV wire 156 receives scrambled or encoded audio and video TV signals transmitted from a TV satellite (not shown) and sends them to IRD 140 for decoding in accordance with a decryption system. IRD 140 sends the decoded TV signals to the TV set (not shown) of the satellite TV subscriber for viewing. A telephone jack 158 is connected to telephone antenna wire 138 and a subscriber telephone (T) 160 is operationally connected to telephone antenna wire 156. Telephone (T) 160 has been assigned a subscriber telephone number (TN) 160A that is accessibly contained in the provider data bank.

Smart access card 152 is mounted in operative relationship with IRD 140. Smart card 152 has been assigned a smart card identification number that distinguishes it from all other smart cards. IRD 142 has also been assigned an IRD identification number that distinguishes it from all other IRDs.

Satellite TV service provider 134 can make an automatic command and periodic check or verification of a match between the smart card identification number and the IRD identification number transmitted from the TV satellite to TV dish antenna 154 by sending both identification numbers to TV dish antenna 154 and from there to IRD 140 in particular to security module 142, which performs the security task of decoding the two identification numbers and examining them for the required match.

Security module 142 includes the software not only for making a match but also more basically has the means to detect any lack of the required match. Security module 142 also has the software means for disabling the transmission of decoded TV signals from IRD 140 to the subscriber TV upon detection of lack of verification of the required match by a signal sent to IRD 140 to terminate decoded audio and video TV signals to the subscriber TV.

As a second security check, satellite TV provider 134 can make an automatic command and periodic check or verification of the operability of the airway signal telephone line connection comprising the cellular telephone airway signals 146 between satellite TV service provider 134 and IRD 140.

IRD 140 is activated by a signal transmitted by the TV satellite or satellite TV provider 134 and immediately or shortly thereafter sends a signal to security module 142 to check that the telephone line connection between the satellite TV provider 134 at a location such as the billing center is operational. If there is no operational connection, security module 142 can initiate an error message to IRD 140 that a message such as by way of example, “NO TELEPHONE LINE DETECTED. PLEASE CHECK CONNECTION” is displayed on the TV set screen of the TV subscriber and thereupon IRD 140 stops decoding the satellite TV signal. The software programmed in security module 142 loops back and continues to check for a telephone line connection on a regular basis. The time interval between the periodic checks can vary.

The assigned identification numbers of smart card 152 and IRD 140 can be alternatively matched by the numbers being transmitted by telephone airway signals 146 to satellite TV provider 134, which has software means which verifies a match between them by comparison with a legitimate subscriber's pair of ID numbers. If the identification numbers of both smart card 152 and IRD 140 do not match, a lack of verification termination signal can be transmitted to the TV satellite to terminate TV service to IRD 140.

If the smart card and IRD identification numbers do not verify, then an error message, such as by way of example, “YOUR SUBSCRIPTION IS NOT VALID. PLEASE CALL CUSTOMER SERVICE” is displayed on the TV set screen and IRD 140 stops decoding the satellite TV signal. When this situation occurs, it may mean the legal subscriber's account has been temporarily suspended, but more than likely, it will be a indication that smart access card 152 was cloned and was not used when IRD 140 was recorded during subscription activation.

In an alternative mode, satellite TV provider 134 makes an automatic command and periodic check or verification of a match between the smart card identification number, the IRD identification number, and the subscriber telephone number (TN) 160A as a subscriber telephone identification number from the TV satellite to TV dish antenna 154 and IRD 140 by sending all three identification numbers to an alternative satellite TV security module 142A, which contains software that performs the security task of verifying the three identification numbers and examining them for the required match. Security module 142A includes the software not only for making a match, but also more basically has the means to detect any lack of the required matches. Security module 142A also has the software means for signaling IRD 140 to disable the transmission of decoded TV signals from IRD 140 to the subscriber TV upon detection of lack of verification of the required matches.

If the smart card, IRD identification, and telephone identification numbers do not verify, then an error message, such as by way of example, “YOUR SUBSCRIPTION IS NOT VALID. PLEASE CALL CUSTOMER SERVICE” is displayed on the TV set screen and IRD 140 stops decoding the satellite TV signal. When this situation occurs, it may mean the legal subscriber's account has been temporarily suspended, but more than likely it will be an indication that smart access card 152 was cloned and was not used when IRD 140 and subscriber telephone number (TN) 160A were recorded during subscription activation. At this point, satellite TV signals are terminated.

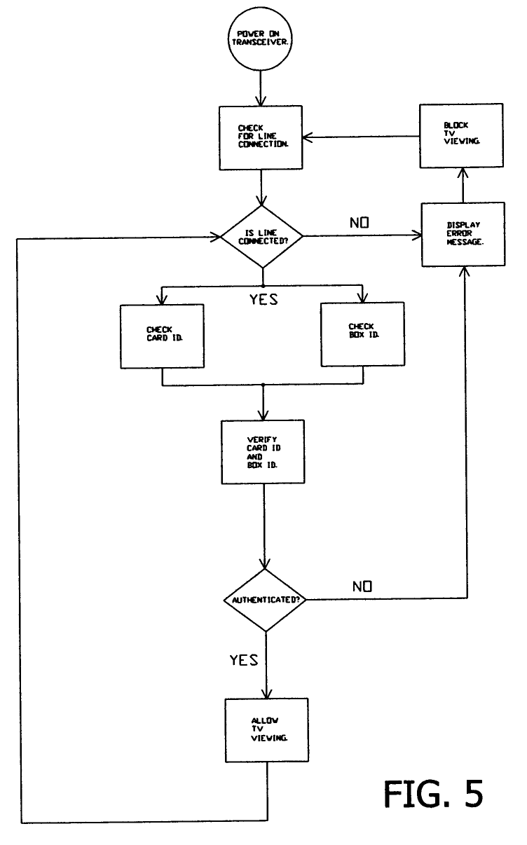

FIG. 5 basically outlines a software program to ensure that a telephone line connection is active at all times in order for TV viewing and that the assigned identification number of the smart card and the assigned identification number of the IRD match. The procedure calls for additional error checking steps to be added to the software code embedded within the IRD and smart card electronics hardware. As seen in FIG. 5, the IRD is powered on and immediately or shortly thereafter, the IRD checks for a telephone line connection to the satellite TV provider or billing center. If there is no connection, an error message like, “NO PHONE LINE DETECTED. PLEASE CHECK CONNECTION” is displayed on the TV set screen and the IRD stops decoding the satellite TV signal. The software loops back and continues to check for a phone line connection on a regular basis. FIG. 5 also outlines a software program to ensure that a match of the identification numbers of the smart card with the data of the IRD is authenticated. If no authentification of a match is made, an error message such as, “YOUR SUBSCRIPTION IS NOT VALID. PLEASE CALL CUSTOMER SERVICE” is displayed on the TV set screen and the IRD stops decoding the satellite TV signal. The software loops back and continues to verify the identification numbers on a regular basis.

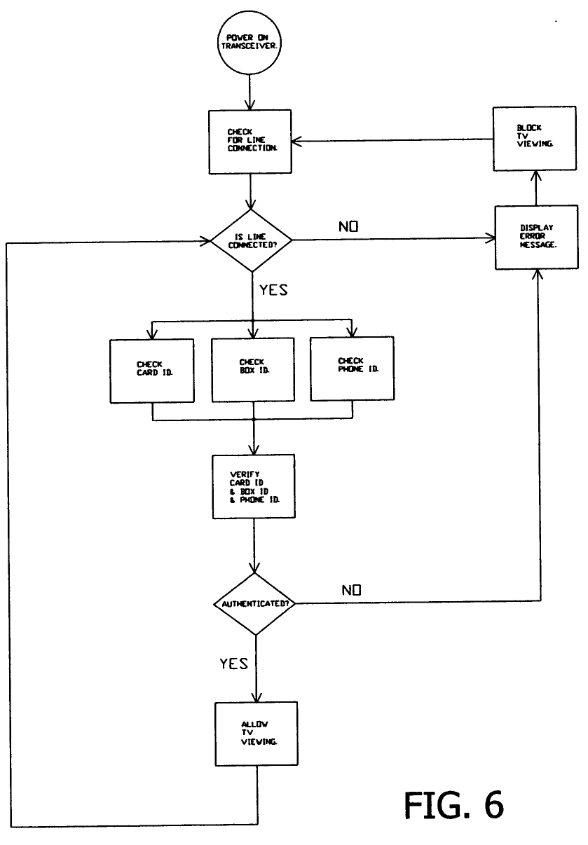

FIG. 6 basically outlines a software program to ensure that a telephone line connection to a location of the satellite TV provider such as a billing center is active at all times in order for TV viewing. In addition the software program ensures that the assigned identification number of the smart card, the assigned identification number of the IRD, and the assigned subscriber telephone number match with the data in the IRD. The procedure calls for additional error checking steps to be added to the software code embedded within the IRD and smart card electronics hardware. As seen in FIG. 6, the IRD is powered on. Immediately or shortly thereafter, the IRD checks for a telephone line connection to the satellite TV provider. If there is no connection, an error message like, “NO PHONE LINE DETECTED. PLEASE CHECK CONNECTION” is displayed on the TV set screen and the IRD stops decoding the satellite TV signal. The software loops back and continues to check for a phone line connection on a regular basis. FIG. 6 also outlines a software program to ensure that a three-way match between the identification numbers of the smart card, the IRD, and also the assigned subscriber telephone number is authenticated. If no authentifications of a three way match is made, an error message such as “YOUR SUBSCRIPTION IS NOT VALID. PLEASE CALL CUSTOMER SERVICE” is displayed on the TV set screen and the IRD stops decoding the satellite TV signal. The software loops back and continues to verify the three identification numbers on a regular basis.

It can be summarized that the legitimate matched identification numbers are stored in a secured satellite TV service provider location and can be downloaded to the TV set top box via a physical phone line connection or downloaded from the TV satellite. The verification of the three identification numbers is automatically performed by the security module or on demand by the satellite TV service provider. In the event authentication is not verified, the security module will communicate to the IRD to stop decoding the satellite TV signal and display an error message, or the satellite TV service provider can send a signal block command directly to the unmatched TV set top box. Various methods of establishing a phone connection communications link between the satellite TV service provider and satellite TV subscriber is presented, but there may be other ways to achieve the benefits of the present invention by others skilled in the art, but the same end results will be achieved.

Although the present invention has been described in some detail by way of illustration and example for purposes of clarity and understanding, it will, of course, be understood that various changes and modifications may be made in the form, details, and arrangements of the parts without departing from the scope of the invention set forth in the following claims.

1. A satellite TV security system including a TV satellite operated by a satellite TV provider directing video and audio TV signals to a television set of a satellite TV subscriber, comprising:
a TV set top box,
a satellite TV dish antenna receiving encoded TV signals from the TV satellite,
an addressable integrated receiver/decoder (IRD) including means for receiving said encoded TV signals transmitted from said satellite TV dish antenna, and for decoding said encoded TV signals, and for transmitting said decoded TV signals to the subscriber television set, said IRD having an assigned IRD identification number and being positioned in said TV set top box,
a modular smart card operationally mounted with said IRD and having input/output means for storing TV subscriber data and TV program data, said smart card having an assigned smart card identification number that is matched to said assigned IRD identification number by the satellite TV provider, said TV satellite transmitting data to said IRD relating to said smart card identification number and to said IRD identification number upon command of the satellite TV provider,
a security module operationally integrated with said IRD and having means for receiving signals of said assigned said smart card identification number and said assigned IRD identification number from said IRD and for periodically verifying the match of said smart card identification number and said IRD identification number and further having means for detecting a lack of verification of a match, and
means for disabling the transmission of said decoded TV signals from said IRD to the subscriber TV upon detection of said lack of verification of a match.

2. The satellite TV security system according to claim 1, wherein said security module includes said means for disabling.

3. The satellite TV security system according to claim 2, wherein said means for disabling includes said security module sending a signal to said IRD to terminate the transmission of said decoded signals to the subscriber TV upon detection of said lack of verification of a match.

4. The satellite TV security system according to claim 1, further including a telephone line connection between the satellite TV provider and said IRD, wherein said security module periodically verifies the operability of said telephone line connection and detects the lack of operability of said telephone line connection.

5. The satellite security system according to claim 4, wherein said security module includes means for disabling the transmission of said decoded TV signals from said IRD to the subscriber TV upon detection of said lack of operability of said telephone line connection.

6. The satellite TV security system according to claim 5, wherein the telephone line connection includes an AC power line and wherein said telephone line connection includes power line carrier communication (PLC) devices connected to said AC power line.

7. The satellite TV security system according to claim 6, wherein said PLC devices include a PLC base modem and a PLC extension modem, said PLC base modem being connected to said AC power line and said PLC extension modem being connected to said AC power line, said PLC extension modem being positioned proximate to said TV set top box in operative connection to said IRD and to said security module.

8. The satellite TV security system according to claim 6, said telephone line connection further including a backup telephone wire operationally independent of said PLC devices, said security system further including a switch operationally mounted to said security module and to said IRD, said switch being selectively movable to activate one of said PLC devices or said backup telephone wire.

9. The satellite TV security system according to claim 5, wherein said telephone line connection includes an array of cellular antennas transmitting telephonic airway signals between said IRD and said satellite TV provider.

10. The satellite TV security system according to claim 2, further including a subscriber telephone operationally connected with said telephone line connection, an assigned subscriber telephone number associated with said subscriber telephone operationally associated with said security module and matched to said assigned IRD identification number and to said assigned smart card identification number by the satellite TV provider,
said TV satellite further transmitting data to said IRD relating to said subscriber assigned telephone number upon command of the satellite TV provider,
said security module further having means for receiving signals of said assigned subscriber telephone number and further having means for periodically verifying a three way match of said smart card identification number, said IRD identification number, and said subscriber telephone number and further having means for detecting a lack of verification of the three way match, said means for disabling further including means for disabling of the transmission of said decoded TV signals from said IRD to the subscriber TV upon detection of said lack of verification of the three way match.

11. A satellite TV security system including a TV satellite operated by a satellite TV provider directing video and audio TV signals to a television set of a satellite TV subscriber, comprising:
a TV set top box,
a satellite TV dish antenna receiving encoded TV signals from the TV satellite,
an addressable integrated receiver/decoder (IRD) including means for receiving said encoded TV signals transmitted from said satellite TV dish antenna for decoding said encoded TV signals and for transmitting decoded TV signals to the subscriber television set,
a telephone line connection extending in operational relationship with the satellite TV provider and said IRD, and
a security module operationally integrated with said IRD, said security module having means for periodically verifying the operability of said telephone line connection and for detecting a lack of said operability of said telephone line connection,
said security module further including means for disabling the transmission of said decoded TV signals from said IRD to the subscriber TV set upon detection of a lack of verification of the operability of said telephone line connection.

12. The satellite TV security system according to claim 11, wherein the telephone line connection includes an AC power line and wherein said telephone line connection includes power line carrier communication (PLC) devices connected to said AC power line.

13. The satellite TV security system according to claim 12, wherein said PLC devices include a PLC base modem and a PLC extension modem, said PLC base modem being connected to said AC power line and said PLC extension modem being connected to said AC power line, said PLC extension modem being positioned proximate to said TV top box in operative connection to said IRD and to said security module.

14. The satellite TV security system according to claim 13, said telephone line connection further including a backup telephone wire operationally independent of said PLC devices, said security system further including a switch operationally mounted to said security module and to said IRD, said switch being selectively movable to activate one of said PLC devices or said backup telephone wire.

15. The satellite TV security system according to claim 14, wherein said telephone line connection includes an array of cellular antennas transmitting telephonic airway signals between said IRD and said satellite TV provider.

16. The satellite TV security system according to claim 15, wherein said IRD has an assigned IRD identification number, and further including a modular smart card having input/output means for storing TV subscriber data and TV program data removably mounted with said IRD, said smart card having an assigned smart card identification number that is matched to said assigned IRD identification number by the satellite TV provider.

17. The satellite TV security system according to claim 16, wherein said security module includes means for receiving signals of said assigned said smart card identification number and said assigned IRD identification number from said IRD and further having means for verifying the match of said smart card identification number and said IRD identification number and further having means for detecting a lack of verification of a match.

18. The satellite security system according to claim 17, said security module further including means for disabling the transmission of said decoded TV signals from said IRD to the subscriber TV upon detection of said lack of verification of a match.

19. The satellite security system according to claim 18, the TV satellite transmitting said smart card identification number and said IRD identification number to said satellite TV dish antenna and to said security module upon command of the satellite TV provider making a periodic verification of a match of said identification numbers.

20. The satellite security system according to claim 19, said security module further having means for receiving said assigned said smart card identification number and said assigned IRD identification number from said IRD and for examining the result of said periodic verification of a match and further having means for detecting a lack of verification of a match.

21. The satellite TV security system according to claim 20, further including a subscriber telephone operationally connected with said telephone line connection, an assigned subscriber telephone number associated with said subscriber telephone and operationally associated with said security module, said assigned subscriber telephone number being matched to said assigned IRD identification number and to said assigned smart card identification number by the satellite TV provider,
said TV satellite further transmitting data to said IRD relating to said subscriber assigned telephone number upon command of the satellite TV provider,
said security module further having means for receiving signals of said assigned subscriber telephone number and wherein said means for periodically verifying further includes a three way match of said smart card identification number, said IRD identification number, and said subscriber telephone number, and wherein said means for detecting a lack of verification further includes means for detecting a lack of verification of the three way match, and wherein said security module further includes means for disabling the transmission of said decoded TV signals from said IRD to the subscriber TV upon detection of said lack of verification of the three way match.

22. The satellite TV security system according to claim 21, wherein said means for disabling further includes said security module sending a signal to said IRD to terminate the transmission of said decoded signals to the subscriber TV upon detection of said lack of verification of the three way match.
